(19) United States
(12) Patent Application Publication
(10) Pub. No.: US 2007/0187167 A1
(43) Pub. Date: Aug. 16, 2007

(54) Machine, in particular construction machine

(76) Inventors: Oliver Mariani, Rankweil (AT); Heinrich Hochleitner, Graz (AT); Hans Knapp, Bischofshofen (AT); Markus Huber, Wagrain (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/653,071

(22) Filed: Jan. 12, 2007

(30) Foreign Application Priority Data
Jan. 13, 2006 (DE) 20 2006 000 516.1
Jan. 17, 2006 (DE) 20 2006 000 664.8

(51) Int. Cl. B60K 17/00

(52) U.S. Cl. 180/305

(57) ABSTRACT

This present disclosure relates to a machine, in particular a construction machine and preferably a wheel loader, comprising a drive unit, a drive train connected with the drive unit for driving the machine, a pump, an energy store connected with the pump, which can be charged by the pump, and an engine which is connected with the energy store and with the drive train or some other component of the machine, wherein the engine is connected with the energy store such that the engine can be driven by the energy store, and wherein the engine is connected with the drive train or the other component such that the energy output by the engine can be introduced into the drive train or into the other component.

### CROSS REFERENCE TO RELATED APPLICATION

This application claims priority to German Utility Models DE 20 2006 000 516.1, filed Jan. 13, 2006 and DE 20 2006 000 664.8, filed Jan. 17, 2006, which are hereby incorporated by reference in their entirety for all purposes.

### FIELD

This present disclosure relates to a machine, in particular a construction machine with a drive unit and with a drive train connected with the drive unit for driving the machine.

### BACKGROUND AND SUMMARY

Such machines are known in a number of different configurations, for instance as construction machines for earth movement, such as wheel loaders and the like. A diesel engine usually is provided as a drive unit of the machine, which effects the travelling drive of the machine for instance via a hydrostatic transmission. For driving the machine, different concepts are known. There is known, for instance, a direct hydrostatic transmission for wheel loaders, in which a variable-displacement swashplate pump cooperates with two bent-axis motors. The size and arrangement thereof at the load-changeable additional transmission allows a plurality of continuously variable driving modes with smooth transitions. One advantage of this concept is that it may provide fuel savings as compared to other configurations.

It is the object underlying the present disclosure to develop a machine as mentioned above such that the efficiency thereof as compared to known machines is further improved.

Accordingly, it is provided that the machine, in particular the construction machine, includes a pump, an energy store connected with the pump, which can be charged by the pump, as well as an engine which is connected with the energy store and with the drive train or some other component of the machine, wherein the engine is connected with the energy store such that the engine can be driven by the energy store, and wherein the engine is connected with the drive train or said other component such that the energy released by the engine can be introduced into the drive train or the other component. Such concept provides for the recovery of energy in that by means of the engine connected with the energy store mechanical energy can be withdrawn, which preferably is introduced into the drive train of the machine. In principle, it is also conceivable to use the mechanical energy of the engine for driving any other component of the machine. Preferably, however, the engine should be coupled to the drive train of the machine. Charging the energy store is effected via a pump, so that for instance in dependence on the operating conditions of the machine there can either be realized the charging of the energy store by the pump or the withdrawal of energy from the energy store for driving the engine.

In some embodiments, it is provided that the pump and the engine are formed by one and the same component. As far as charging is concerned, this component converts mechanical energy into hydraulic energy for charging the store. As far as the withdrawal of energy is concerned, i.e. the recovery of energy, the component is operated as a hydraulic motor which converts the hydraulic energy of the energy store into mechanical energy, which can for instance be fed into the drive train at any point.

In accordance with a further embodiment, it is provided that the pump is directly or indirectly driven by the drive unit of the machine, i.e. for instance by a diesel engine, or by the drive train.

Furthermore, it can be provided that the pump is connected with the drive unit or with the drive train via a releasable clutch, by means of which the pump can be separated from the drive unit or from the drive train. It is conceivable to uncouple the pump or the hydraulic motor from the drive unit or from the drive train, if necessary or in dependence on the operating condition of the machine.

Machines such as wheel loaders include shafts which are running without or with only minor fluctuations in speed, such as the input shaft of the diesel engine. In accordance with another embodiment, it is therefore provided that the machine includes at least one such shaft, whose speed is constant during operation of the machine or which is operated within a relatively narrow speed range during operation of the machine, and which is connected with the pump for driving the pump. It is also provided that on such a shaft running within a small speed range, such as the input shaft, a pump is mounted, which is used for charging the energy store. As stated above, this shaft is running with a constant speed or within a speed range that is narrow as compared to the output-end speed range of a transmission, which involves the advantage that the pump design is simplified and the pump can run within an optimum operating range.

It is conceivable that the shaft includes a releasable clutch or is connected with such clutch, by means of which the pump or the hydraulic motor can be disengaged from the shaft or from the drive unit or drive train driving the same, so that with disengaged clutch the operation of the drive unit or the shaft will not lead to an actuation of the pump.

In accordance with a further embodiment, the speed range, in which the shaft is operated, is narrower than the output-end speed range of the machine transmission. The latter covers the entire speed range, for instance 0 to 3,500 rpm, of the driving speeds of the machine. The speed range in which the shaft is operated can for instance be half, a third, a quarter or the like of the output-end speed range of the machine transmission.

The speed range in which the shaft is operated can correspond to the speed range in which the drive unit of the machine is operated or can form a subrange thereof. It is conceivable, for instance, that the diesel engine of the machine is operated in a speed range between 800 and 2000 rpm and frequently at 1800 rpm, and that said shaft driving the pump is also operated in this speed range. It is also conceivable to operate the shaft only within a speed range which forms a subrange (half, a quarter, etc.) of the speed range of the drive unit.

At any point of the drive train of the machine, the mechanical energy output by the engine can be fed into the drive train of the machine or also into some other component to be driven. Preferably, the engine is connected with the shaft such that said shaft can be driven by the engine. This is the case when the pump and the engine are formed by one and the same component in accordance with a preferred aspect of the present disclosure.

The shaft which drives the pump can correspond to the input shaft of the drive unit or be connected with the same. The drive unit of the machine in some embodiments is an internal combustion engine, and in some specific embodiments is a diesel engine, and it can be provided that the shaft driving the pump is formed by the input shaft of the internal combustion engine.

The machine can include a transmission, in particular a power take-off transmission or generally a continuously variable transmission. It can be provided that the drive end of the transmission is formed by said shaft, whose speed is constant during operation of the machine or which is operated within a relatively narrow speed range during operation of the machine. It can, of course, likewise be provided that the drive is not realized by such transmission, but that the drive unit is a mechanical train, such as an internal combustion/torque converter transmission. Even in these cases there are shafts running without or with minor fluctuations in speed, such as the input shaft of the diesel engine.

In accordance with another embodiment, the pump is a variable-displacement pump. The pump can be configured as an oil pump.

The energy store largely can have any design. It is, for instance, conceivable that it is a tank in which a spring, in particular a gas spring, is provided. Of course, other types of energy store are also conceivable.

In accordance with another embodiment, it is provided that the machine includes a control unit which controls the feeding of energy into the energy store and/or the withdrawal of energy from the energy store. It is, for instance, conceivable that the control unit is configured such that it initiates the feeding of energy into the energy store when the machine is inoperative or is operated with a low driving speed, and initiates the withdrawal of energy from the energy store when the machine is driving or is operated with a higher driving speed.

In accordance with another embodiment, it is provided that the control unit is configured such that it controls the feeding of energy into the energy store and/or the withdrawal of energy from the energy store in dependence on the driving speed of the machine.

In principle, other operating modes of the control unit are of course also conceivable. For instance, the feeding of energy into the energy store and/or the withdrawal of energy from the energy store can also be made dependent on whether or to what extent the working tool of the machine is operated.

In accordance with another embodiment, it is provided that the control unit is an electronic control unit.

### BRIEF DESCRIPTION OF THE FIGURES

Further details and advantages of the present disclosure will be explained in detail with reference to an embodiment illustrated in the drawing, in which:

FIG. 1 shows a schematic representation of a driveable machine in the form of a wheel loader in accordance with the present disclosure; and

FIG. 2 shows a schematic representation of a driveable machine in the form of a wheel loader in accordance with the present disclosure in another embodiment.

### DETAILED DESCRIPTION

The embodiments of a wheel loader as shown in the Figures illustrate the inventive principle for the recovery of energy in hydraulic machines by creating a pump, an engine and a pressure accumulator. The present disclosure can of course also be considered for machines other than wheel loaders.

By means of the present disclosure, the efficiency of the system should be maintained under favorable conditions over the entire speed range of the vehicle, for instance the wheel loader or the like.

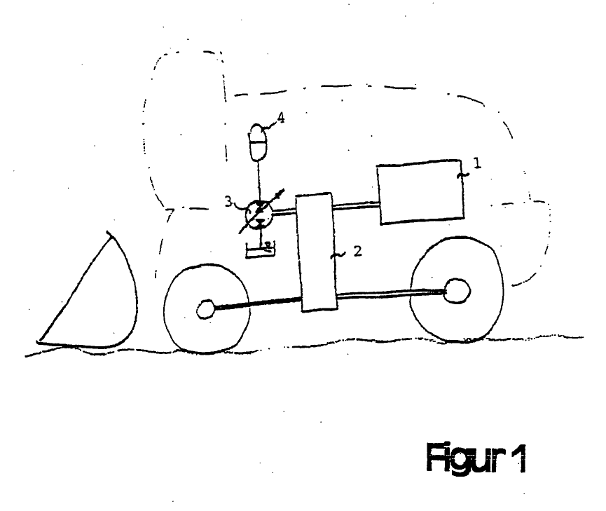

As shown in FIG. 1, the wheel loader includes an internal combustion engine, in particular a diesel engine 1 or the like, as a travelling drive of the machine. The drive train of the machine extends from the same. Via the input shaft, the diesel engine 1 is connected with a transmission 2, which can be a power take-off transmission or generally a continuously variable transmission. In a hydrostatic power take-off transmission, the input power is divided into a low-loss mechanical path and a hydrostatic path and is united again behind the continuously variable hydrostatic partial transmission. In a continuously variable hydrostatic transmission it is generally provided that preferably a variable-displacement pump delivers in a closed circuit to a constant or adjustable oil engine, which enables a stepless starting and preferably also a reversing of the drive by swinging the pump. It is likewise conceivable to apply the present disclosure to drives which include a mechanical train, such as an internal combustion/torque converter transmission. In the Figure, the transmission is generally designated by the reference numeral 2.

Machines, in particular wheel loaders, include shafts running with little fluctuations in speed, such as the input shaft of the diesel engine 1, which in the drawing is shown between the diesel engine 1 and the transmission 2. In particular in power take-off and continuously variable transmissions it can, for instance, always be maintained within the optimum speed range of the internal combustion engine (for instance in a range between 800 and 2000 rpm). Meanwhile, the output end of the transmission 2 must run through the entire speed range of the associated driving speed (for instance a range between 0 and 3500 rpm).

As can furthermore be taken from FIG. 1, an oil pump 3 is mounted on the input shaft running within a small speed range, which oil pump is driven by the input shaft, i.e. converts mechanical energy into hydraulic energy. The oil pump 3 is a variable-displacement pump.

The variable-displacement pump 3 is connected with an energy store 4, which can for instance be formed by an oil tank with a gas spring. In principle, other types of energy store are of course also conceivable.

There is furthermore provided a non-illustrated control unit, which controls the storage of energy into the energy store 4 as well as the recovery of energy from the energy store 4. It is conceivable that the process of storing energy and the process of recovering energy are made dependent on various parameters, such as in particular the operating conditions of the machine. It is conceivable, for instance, that for the case that the machine is inoperative, charging the energy store 4 is effected by means of the pump 3. In driving operation, it can be provided that the pump 3 then is operated as a hydraulic motor which withdraws energy from the store 4 and converts the same into mechanical energy and feeds the same into the input shaft, so that the energy content of the store can be fed into the drive train and thus supports the driving operation. The engine 1 can be arranged such that its mechanical energy is introduced at any point. What is conceivable, for instance, is said shaft as well as any other point of the drive train including the wheels of the machine.

As can furthermore be taken from FIG. 1, the pump 3 or the hydraulic motor 3 are connected with a sump from which and into which hydraulic medium, in particular oil, is supplied.

The present disclosure provides for keeping the efficiency of the machine under favorable conditions over the entire speed range of the vehicle. In the embodiment shown in the Figure, the pump and the hydraulic motor are formed by one and the same component. In principle, it is likewise conceivable to provide two different components for this purpose, and the mechanical energy of the engine can also be introduced at any point of the drive train or at some other point.

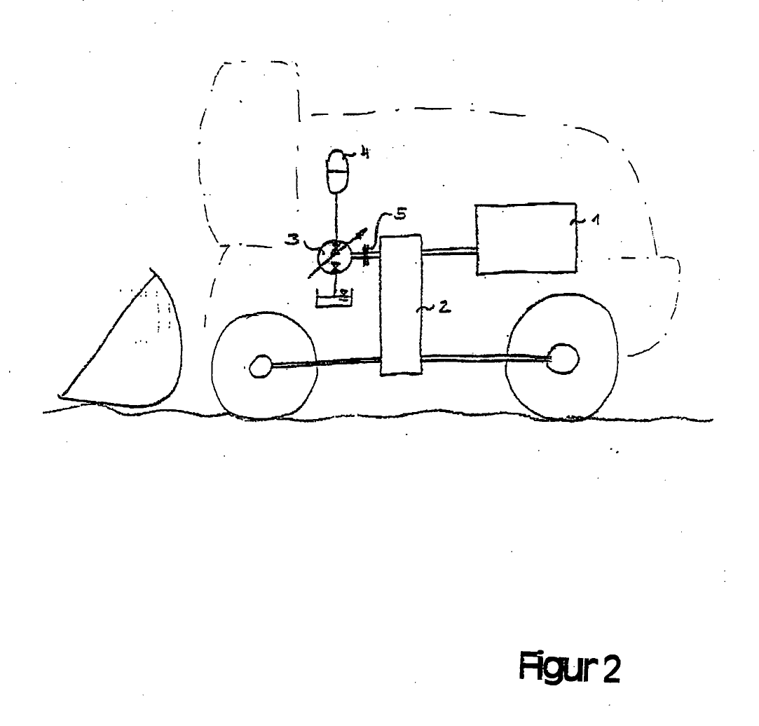

FIG. 2 shows another embodiment of the present disclosure, likewise in the form of a wheel loader. Identical parts or parts having the same effect are designated with the same reference numerals as in FIG. 1.

As can be taken from FIG. 2, the pump 3 for charging the store 4 or the hydraulic motor 3 for recirculating the stored energy to the drive train are connected with the drive train via a releasable clutch 5. Preferably, the clutch is arranged at the above-mentioned input shaft which runs within a small speed range. It provides for uncoupling the pump 3 or the hydraulic motor 3 from the drive train under certain operating conditions, in which an actuation of the pump is not required or not desired.

1. A construction machine, comprising a drive unit, a drive train connected with the drive unit for driving the machine, a pump, an energy store connected with the pump, which can be charged by the pump, and an engine which is connected with the energy store and with the drive train or some other component of the machine, wherein the engine is connected with the energy store such that the engine can be driven by the energy store, and wherein the engine is connected with the drive train or the other component such that the energy output by the engine can be introduced into the drive train or into the other component.

2. The machine as claimed in claim 1, characterized in that the pump and the engine are formed by the same component.

3. The machine as claimed in claim 1, characterized in that the pump is arranged such that it can directly or indirectly be driven by the drive unit of the machine.

4. The machine as claimed in claim 1, characterized in that the pump is arranged such that it can directly or indirectly be driven by the drive train of the machine.

5. The machine as claimed in claim 1, characterized in that the pump is connected with the drive unit or with the drive train via a releasable clutch by means of which the pump can be disengaged from the drive unit or from the drive train.

6. The machine as claimed in claim 1, characterized in that the machine includes at least one shaft whose speed is constant during operation of the machine or which is operated within a comparatively narrow speed range during operation of the machine, and which is connected or connectable with the pump for driving the same.

7. The machine as claimed in claim 6, characterized in that the machine includes a transmission and that the speed range in which the shaft is operated is narrower than the output-end speed range of the transmission.

8. The machine as claimed in claim 6, characterized in that the speed range in which the shaft is operated corresponds to the speed range with which the drive unit of the machine is operated or forms a subrange thereof.

9. The machine as claimed in any of claim 6, characterized in that the engine is connected with the shaft such that the shaft can be driven by the engine.

10. The machine as claimed in any of claim 6, characterized in that the shaft which drives the pump constitutes the input shaft of the drive unit or is connected with the same.

11. The machine as claimed in claim 1, characterized in that the drive unit of the machine is a diesel internal combustion engine.

12. The machine as claimed in claim 1, characterized in that the machine includes a continuously variable transmission.

13. The machine as claimed in claim 6, characterized in that the drive end of the transmission is formed by the shaft, whose speed is constant during operation of the machine or which is operated within a narrow speed range during operation of the machine.

14. The machine of claim 1, characterized in that the pump is a variable-displacement pump.

15. The machine of claim 1, characterized in that the pump is an oil pump.

16. The machine as claimed in claim 1, characterized in that the energy store is a tank in which a gas spring is provided.

17. The machine as claimed in claim 1, characterized in that a control unit is provided, which controls the feeding of energy into the energy store and/or the withdrawal of energy from the energy store.

18. The machine as claimed in claim 17, characterized in that the control unit is configured such that it initiates the feeding of energy into the energy store when the machine is inoperative or is operated with a low driving speed, and initiates the withdrawal of energy from the energy store when the machine is operated with a comparatively higher driving speed.

19. The machine as claimed in claim 17, characterized in that the control unit is configured such that the feeding of energy into the energy store and/or the withdrawal of energy from the energy store is controlled in dependence on the driving speed.

20. The machine as claimed in any of claim 17, characterized in that the control unit is an electronic control unit.
